(19) United States
(12) Patent Application Publication
(10) Pub. No.: US 2026/0238969 A1
(43) Pub. Date: Aug. 13, 2026

(54) System and Method for Configuring an Electronic Vehicle Key

(71) Applicant: Bayerische Motoren Werke Aktiengesellschaft, Muenchen (DE)

(72) Inventors: Christian BUCHNER, Poing (DE); Kai HOESL, Iffeldorf (DE)

(21) Appl. No.: 19/531,803

(22) Filed: Feb. 6, 2026

(30) Foreign Application Priority Data
Feb. 7, 2025 (DE) 10 2025 104 632.8

(51) Int. Cl. H04W 4/44; B60R 25/24; H04W 4/80

(52) U.S. Cl. CPC H04W 4/44; H04W 4/80; B60R 25/24; B60R 2325/101; B60R 2325/103

(57) ABSTRACT

In a device and a method for configuring a remote control as an electronic vehicle key for a vehicle, with the aid of a vehicle processing unit, a remote control, a mobile terminal which includes a digital vehicle master key, and an external processing unit, a subordinate digital vehicle subkey is generated for the vehicle and stored on the remote control. The mobile terminal or the vehicle processing unit is used in this case as an interconnected transfer unit between the remote control and the external processing unit.

### CROSS REFERENCE TO RELATED APPLICATION

This application claims priority under 35 U.S.C. § 119 from German Patent Application No. 10 2025 104 632.8, filed Feb. 7, 2025, the entire disclosure of which is herein expressly incorporated by reference.

### BACKGROUND AND SUMMARY

The invention relates to a system and a method for configuring a remote control as an electronic vehicle key for a vehicle. A digital vehicle key is generated here.

Known vehicles can also be used with digital vehicle keys alternatively or additionally to physical vehicle keys. Digital vehicle keys are generated with the aid of servers provided for this purpose and a mobile terminal and are stored on the mobile terminal. Compatible vehicles are thus capable of recognizing a matching digital vehicle key and enabling a use of the vehicle. For this purpose, the vehicle and a mobile terminal communicate using the digital vehicle key with the aid of ultra-wideband technology (UWB), Bluetooth low energy radio technology (BLE), or near field communication (NFC).

Document US 2024/0257590 A1 discloses a mobile terminal having data for a digital vehicle key. The mobile terminal having the digital vehicle key is configured so that it can be used as a vehicle key for a vehicle.

The document “Car Connectivity Consortium, Digital key Release 3, Technical Specification, Version 1.2.0, (CCC-TS-101)” discloses a standardized method for generating digital vehicle keys on smart phones.

The object of the invention is to specify a simple system and a simple method for configuring a remote control as an electronic vehicle key for a vehicle.

This object is achieved by a system and by a method having the features of the independent claims. Advantageous refinements are specified in the dependent claims.

With the aid of the system, a remote control can be configured particularly easily as an electronic vehicle key for a vehicle. This is achieved in that a remote control to be trained on a vehicle can be configured individually and securely. The remote control to be trained can be individually configured easily, since an end user, which has a mobile terminal having a digital master vehicle key for the vehicle, only still has to acquire the remote control to be trained. As soon as the remote control has been acquired, the user can already configure the remote control to be trained as an electronic vehicle key with the aid of the system, i.e., to train the remote control on the vehicle. For this purpose, the remote control to be trained is configured using a digital vehicle subkey for the vehicle. Furthermore, the remote control to be trained can be securely configured, since the mobile terminal having the digital master vehicle key is required for the configuration. Furthermore, an external processing unit is also required, which is designed to secure and log a data transfer to generate the digital vehicle subkey for the vehicle. A remote control to be trained can thus only be configured as an electronic vehicle key if an authorized person, thus a user of the digital master vehicle key, initiates the configuration via the external processing unit. The configuration by an authorized person can be ensured, for example, with the aid of signature chains, so-called certificate chains. With the aid of these certificate chains, the correct method sequence is protected from manipulation, documented, and verified during the communication between remote control to be trained, external processing unit, mobile terminal, and optionally the vehicle processing unit. In one embodiment, the data transfer between the interconnected transfer unit and the external processing unit takes place, for example, with the aid of an Internet connection. The mobile terminal and/or the vehicle processing unit are then designed, for example, to communicate with the external processing unit with the aid of WLAN, Wi-Fi, and/or mobile wireless.

An electronic vehicle key is a trained remote control which was trained on a vehicle using a digital vehicle subkey and using which specific vehicle functions can be triggered. These vehicle functions are, for example, opening, starting, unlocking, and locking the vehicle. For this purpose, the trained remote control is configured to send radio signals, which transmit a command and were generated on the basis of the digital vehicle subkey, to the vehicle. The vehicle is designed to receive the radio signals, to recognize that the radio signals were generated on the basis of a digital vehicle key for the vehicle, and then to execute the command transmitted with the aid of the radio signals.

The mobile terminal is, for example, a smart phone or a smart watch. The mobile terminal is furthermore designed to comprise a digital vehicle key, for example on a so-called secure element, of the mobile terminal. The digital vehicle key comprises data which enable a terminal, on which the digital vehicle key is located, to send radio signals, which transmit a command and were generated on the basis of the digital vehicle key, to the vehicle. The digital vehicle key can also be a digital vehicle master key. The digital vehicle master key comprises additional data which enable a mobile terminal, on which the digital vehicle master key is located, to generate subordinate digital vehicle keys as digital vehicle subkeys on further terminals with the aid of at least one external processing unit.

The external processing unit is designed to communicate at least with the mobile terminal and/or the vehicle processing unit with the aid of WLAN, Wi-Fi, and/or mobile wireless and is, for example, a server. The external processing unit can be designed, for example, to ensure a secure data transfer during the generation of digital vehicle subkeys on further terminals.

In one embodiment, the external processing unit or a further external processing unit can be designed to provide a management environment for digital vehicle subkeys, which were generated with the aid of the external processing unit and the mobile terminal which comprises the digital vehicle master key. The external processing unit or the further external processing unit comprises, in such an embodiment, for example, data on the digital vehicle subkey, which were generated with the aid of the external processing unit and the mobile terminal. The digital vehicle master key then comprises, for example, data which enable the mobile terminal, on which the digital vehicle master key is located, to block digital vehicle subkeys on further terminals with the aid of the external processing unit or the further external processing unit. The external processing unit or the further external processing unit can be designed for this purpose, for example, to transfer data to the vehicle and receive data from the vehicle with the aid of WLAN, Wi-Fi, and/or mobile wireless. In this way, if the trained remote control is lost, the digital vehicle subkey is no longer accepted by the vehicle. A use of the vehicle by unauthorized parties can thus be prevented.

It is advantageous if the remote control is not capable of establishing an Internet connection to the at least one external processing unit with the aid of mobile wireless, Wi-Fi, or WLAN without the interconnected transmission unit. In this way, hardware components can be saved in the remote control and the operation of the remote control is less complex. In addition, the production costs for the remote control are reduced and the security from manipulation is enhanced by the absence of the mobile wireless, Wi-Fi, and WLAN transmission options.

It is advantageous if the remote control to be trained and at least either the mobile terminal or a vehicle processing unit are designed to communicate with one another with the aid of near field communication. In this way, a data transfer between the remote control to be trained and the mobile terminal or the vehicle processing unit is particularly secure, since both devices have to be located within a distance of 10 cm from one another for this data transfer.

It is advantageous if the remote control to be trained and at least either the mobile terminal or the vehicle processing unit are designed to communicate with one another with the aid of Bluetooth communication. In this way, a data transfer between the remote control to be trained and either the mobile terminal or the vehicle processing unit is very simple. The data transfer is simple since the remote control to be trained simply can be selected for coupling with the aid of the data transfer unit and since the data transfer can take place, for example, over a range of 0 m to 100 m, for example, 0 m to 40 m.

It is advantageous if the remote control to be trained and either the mobile terminal or the vehicle processing unit are designed to communicate with one another with the aid of UWB communication. In this way, a data transfer between the remote control to be trained and either the mobile terminal or the vehicle processing unit is very simple and secure. The data transfer is simple since the data transfer can take place, for example, over a range of 0 m to 40 m, for example, 0 m to 10 m. The data transfer is additionally secure sense in the case of the UWB communication, simultaneously with the data transfer, a relative location determination of the remote control to be trained and either the mobile terminal or the vehicle processing unit can be carried out. A data transfer thus only takes place, for example, if the remote control to be trained and either the mobile terminal or the vehicle processing unit are located at a detected distance from one another. The permissible detected distance can preferably be preset to a distance in the range of 0 m to 2 m, in particular in the range of 0 m to 1 m. In this way, for example, a data transfer to a remote control, which is not intended as the remote control to be configured, can be prevented.

It is advantageous if the system comprises at least one further vehicle having a further vehicle processing unit. The mobile terminal then comprises, for example, a further digital vehicle master key for the further vehicle. Alternatively or additionally, the system comprises, for example, a further mobile terminal which comprises the further digital vehicle master key for the further vehicle. The remote control to be trained is then designed, for example, to also be trained for the further vehicle in addition to the vehicle. Furthermore, at least the external processing unit is designed to secure and log the data transfer for generating the further digital vehicle subkey for the further vehicle. The remote control to be trained is furthermore, for example, designed to generate and store a digital vehicle subkey valid for the further vehicle with the aid of the external processing unit and the further mobile terminal, which comprises the further digital vehicle master key for the further vehicle. Alternatively or additionally, the remote control to be trained is designed to generate and store the digital vehicle subkey valid for the further vehicle with the aid of the external processing unit and with the aid of the mobile terminal, which comprises the further digital vehicle master key for the further vehicle. Furthermore, for example, the further mobile terminal is additionally designed to enable, as an interconnected transfer unit, a data transfer between the external processing unit and the remote control to be trained. Alternatively or additionally, for example, the further vehicle processing unit is designed to enable, as an interconnected transfer unit, a data transfer between the external processing unit and the remote control to be trained. In a further embodiment, the remote control is already trained on the vehicle and is trained on the further vehicle with the aid of the system. In this way, a remote control can be trained on multiple vehicles, so that the multiple vehicles can be actuated with the aid of the same remote control. The number of the required keys or the required remote controls for using different vehicles can thus be reduced.

In a second aspect of the invention, a remote control is disclosed which is designed to be configured as an electronic vehicle key for a vehicle. The remote control is furthermore designed to communicate at least with the aid of near field communication. Furthermore, the remote control is designed to establish, with the aid of the interconnected transfer unit, a data connection to the at least one external processing unit, which is designed to secure and log the data transfer for generating a digital vehicle subkey for the vehicle. The remote control is furthermore designed to generate and store the digital vehicle subkey for the vehicle with the aid of the mobile terminal, which comprises the digital vehicle master key, and the external processing unit. After the configuration as an electronic vehicle key, the remote control thus trained enables users of a digital vehicle master key on a non-UWB-capable smart phone to use UWB-dependent functions of the digital vehicle key in a simple, cost-effective, and lasting manner. The use of the UWB-dependent functions is simplified for the user of the digital vehicle master key since the user can configure the remote control to be trained himself independently of third parties. The use of the UWB-dependent functions takes place in a cost-effective and lasting manner, since the user does not have to buy a new UWB-capable mobile terminal, such as a UWB-capable smart phone, but rather only the remote control to be trained, so that resources can be saved.

It is advantageous if the remote control is designed to transfer data with the aid of a Bluetooth data connection and a UWB data connection. A data transfer is possible in this way within a range of, for example, 0 to 40 m, for example, 0 to 10 m. Furthermore, the data connection is thus particularly well protected against so-called relay attacks, since a location of the sender relative to the receiver can be ascertained simultaneously with the UWB data connection. In a relay attack, for example, the interconnected transfer unit would suggest that the remote control were located in the vicinity as the transmitting unit, even if this is not the case.

In one embodiment, the remote control only has buttons as operating elements. In this way, the remote control can be handled particularly easily and is less expensive proceeding from the material value and the production costs for the remote control than a remote control having a touchscreen as an operating element. In one embodiment, the remote control has no operating elements. In this way, the remote control is less susceptible to wear.

In a third aspect of the invention, a method for configuring a remote control as an electronic vehicle key for a vehicle is disclosed. In the method, the remote control to be trained generates and stores, with the aid of a mobile terminal and at least one external processing unit, a digital vehicle subkey valid for the vehicle. In this case, the mobile terminal comprises a digital vehicle master key for the vehicle and the external processing unit secures the data transfer for generating the digital vehicle subkey for the vehicle and logs it. Furthermore, with the aid of the mobile terminal or with the aid of a vehicle processing unit, data are transferred between the external processing unit and the remote control to be trained. The method having the features of the independent method claim has the same advantages as the claimed device. In particular, the method can be refined by the features of the dependent claims directed to the device and the above-mentioned refinements.

It is advantageous if the remote control to be trained generates and stores, with the aid of the mobile terminal and the external processing unit, a digital vehicle subkey having restricted function for the vehicle. In this case, at least one restriction for the digital vehicle subkey is defined with the aid of the mobile terminal. In this way, the extent to which the vehicle can be used using the digital vehicle subkey can be easily restricted.

It is advantageous if the at least one restriction is a restriction of a usage period of time, a restriction of openable vehicle parts, a restriction of the usability of an infotainment system, or a restriction of the usability of a navigation system. The private sphere of the user of the digital vehicle master key can be protected particularly well in this way, since a user of the digital vehicle subkey can be restricted in, for example, opening the glove compartment or viewing driving routes which have been traveled. Furthermore, the user of the digital vehicle master key can ensure the availability of the vehicle for his own use by the setting of usage periods of time of the vehicle using the digital vehicle subkey.

Exemplary embodiments are explained in more detail hereinafter on the basis of the figures.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic representation of a remote control,

FIG. 2 shows a communication scheme of a system for configuring a remote control as an electronic vehicle key for a vehicle, and

FIG. 3 shows a further communication scheme of a system for configuring a remote control as an electronic vehicle key for a vehicle.

### DETAILED DESCRIPTION OF THE DRAWINGS

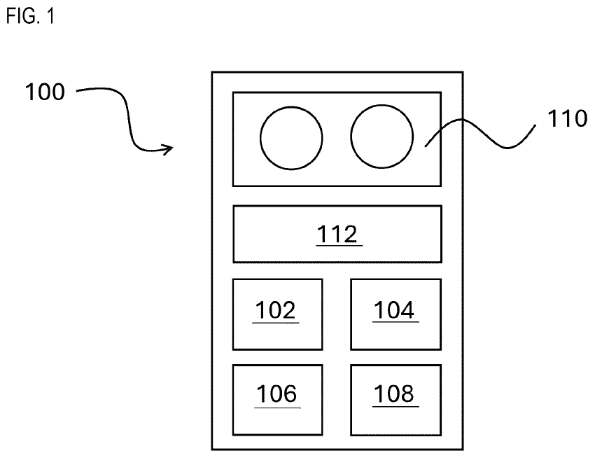

FIG. 1 shows a schematic representation of a remote control 100. The remote control 100 comprises a so-called secure element 102. This hardware component enables manipulation-secure generating and storage of digital vehicle keys in the remote control 100.

The remote control 100 furthermore comprises a near field communication unit 104. Data can be transferred from the remote control 100 to further target devices, which likewise comprise a near field communication unit 104, with the aid of the near field communication unit 104, and vice versa. In addition, the remote control 100 and the target device have to be located at a distance of at most 10 cm for a data transfer, so that the data transfer is especially secure and controllable.

The remote control 100 furthermore comprises a Bluetooth communication unit 106. Data can be transferred from the remote control 100 to further target devices, which likewise comprise a Bluetooth communication unit 106, with the aid of the Bluetooth communication unit 106, and vice versa. In addition, the data transfer between the remote control 100 and the target device with the aid of Bluetooth communication is very easy, since both devices can easily be coupled and since the data transfer can take place, for example, over a range of 0 m to 100 m, for example, 0 m to 40 m.

The remote control 100 furthermore comprises a UWB communication unit 108. Data can be transferred from the remote control 100 to further target devices, which likewise comprise a UWB communication unit 108, with the aid of the UWB communication unit 108, and vice versa. In addition, the data transfer is very easy, since the data transfer can take place, for example, over a range of 0 m to 40 m, for example, 0 m to 10 m. The data transfer is additionally very secure, since in the UWB communication, simultaneously with the data transfer, a relative location determination of the remote control 100 and the further target device can be carried out. The data transfer is thus protected against so-called relay attacks, in which it is suggested to a target device that the remote control 100 is located in the vicinity as the sending unit, even if this is not the case. Bluetooth communication and UWB communication can also be used together, for example, with the aid of the remote control 100 in order to combine the advantages of easy coupling, communication over a distance, and location determination.

The remote control 100 furthermore comprises a remote-control processing unit 112. The remote-control processing unit 112 is designed, for example, to communicate at least either with a mobile terminal 202, as an interconnected transfer unit 202, or with a vehicle processing unit 302, as an interconnected transfer unit 302. Furthermore, the remote-control processing unit 112 is furthermore designed, for example, to exchange data with an external processing unit 204 with the aid of the interconnected transfer unit 202, 302 and to generate a digital vehicle subkey on the secure element 102 with the aid of the external processing unit 204 and the mobile terminal 202. For this purpose, the remote-control processing unit 112 can be designed, for example, to execute a framework program, a so-called digital key framework. In one embodiment, the secure element 102 can be designed to execute an application for generating the digital vehicle subkey.

The remote control 100 furthermore comprises a control panel having buttons 110. If the remote control 100 is configured as an electronic vehicle key for a vehicle, the buttons 110 are capable, for example, of triggering a function of the vehicle. The buttons 110 can furthermore be capable, for example, of managing and, for example, deleting a digital vehicle subkey which is stored on the trained remote control 100. For this purpose, the remote control 100 can be designed, for example, to execute a program specific for the digital vehicle key, a so-called native app. In a further embodiment, the remote control 100 does not have a control panel having buttons 110. If the remote control 100 is configured as an electronic vehicle key for the vehicle, the vehicle can be opened by a person, for example, when the trained remote control 100 is located at a predetermined maximum distance to the vehicle.

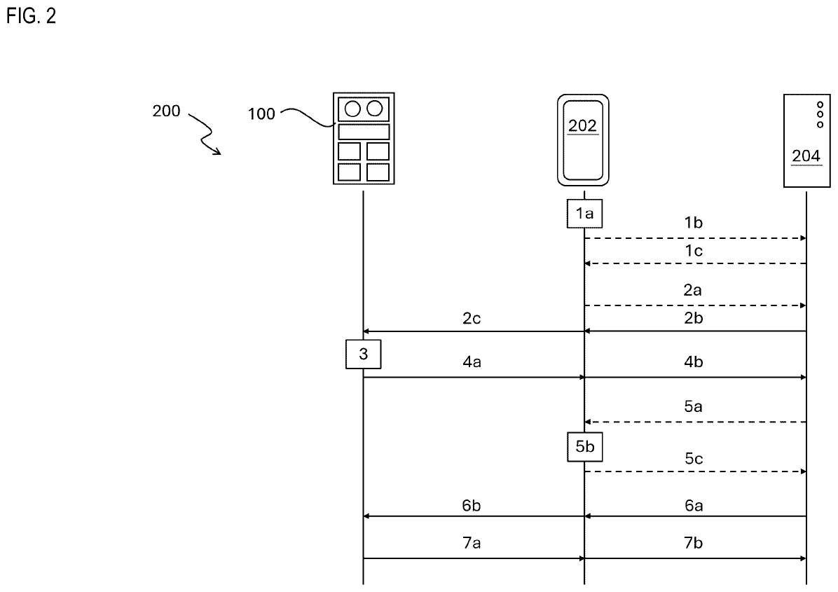

FIG. 2 shows a communication scheme 200 of a system for configuring a remote control 100 as an electronic vehicle key for a vehicle. The remote control 100, a mobile terminal 202, and an external processing unit 204 are shown thereon. Furthermore, data transfer arrows and exemplary method steps 1a to 7b for configuring the remote control 100 as an electronic vehicle key for the vehicle are shown. The data transfer arrows are each shown as solid or dashed and indicate from where and to where data are transferred. In the case of dashed arrows, the data transfer takes place due to a step in the creation of the digital vehicle subkey which contributes to the authentication of the digital vehicle subkey. For example, the expansion of a signature chain or a so-called certificate chain contributes to the authentication. In the case of solid arrows, the mobile terminal 202 functions as an interconnected transfer unit 202 between the remote control 100 and the external processing unit 204. The mobile terminal 202 and the remote control 100 are located at a distance within which both devices can communicate with one another with the aid of near field communication. In this embodiment, the data transfer between the mobile terminal 202 and the remote control 100 takes place with the aid of near field communication. In one embodiment, the data transfer alternatively or additionally takes place with the aid of Bluetooth communication. In a further embodiment, the data transfer alternatively or additionally takes place with the aid of UWB communication.

In step 1a, a user of the mobile terminal 202, which comprises the digital vehicle master key, gives the command with the aid of the mobile terminal 202 to create a digital vehicle subkey on the remote control 100. Data are then generated in step 1b, for example on the basis of an application for digital vehicle keys which is executed on the mobile terminal 202. The data generated in step 1b are transferred from the mobile terminal 202 to the external processing unit 204 and prepare the external processing unit 204 for the creation of the digital vehicle subkey. In step 1c, data are transferred from the external processing unit 204 to the mobile terminal 202, wherein the data comprise information on a target environment to be actuated of the external processing unit 204 for the creation of the digital vehicle subkey. Any data transfer from and to the external processing unit 204 then takes place, for example, between step 1c and step 6a inclusive from and to the target environment of the external processing unit 204 to be actuated. The target environment to be actuated creates, for example, a secure and logged channel for the data transfer between the mobile terminal 202 and the remote control 100. In one embodiment, the target environment to be actuated is implemented by an electronic mailbox, a so-called mailbox.

In step 2a, data are created by the mobile terminal 202 on the basis of the digital vehicle master key and transferred to the external processing unit 204. The data created in step 2a are then transferred in steps 2b and 2c to the remote control 100, wherein the data are first transferred to the mobile terminal 202 in step 2b and then to the remote control in step 2c.

The remote control 100 then generates, in step 3, data on the basis of the received data, which were created on the basis of the digital vehicle master key, which comprise an unsigned digital vehicle subkey. The data which comprise the unsigned digital vehicle subkey are not yet sufficient for the configuration of the remote control 100 as an electronic vehicle key. The data generated in step 3 furthermore comprise data to be signed.

The data to be signed are then transferred in steps 4a and 4b from the remote control 100 to the external processing unit 204. For this purpose, the data are first transferred in step 4a to the mobile terminal 202 and then in step 4b from the mobile terminal 202 to the external processing unit 204.

The data to be signed are then transferred, in step 5a, from the external processing unit 204 to the mobile terminal 202. The mobile terminal 202 then signs, in step 5b, the data to be signed on the basis of the data on the digital vehicle master key. These signed data are then transferred, in step 5c, from the mobile terminal 202 to the external processing unit 204.

The signed data are then transferred in steps 6a and 6b to the remote control 100, wherein the data are first transferred in step 6a to the mobile terminal 202 and then in step 6b to the remote control. As soon as the remote control 100 has received the signed data, the remote control 100 comprises a signed digital vehicle subkey, so that the remote control 100 is configured as an electronic vehicle key. The remote control 100 is thus trained for the vehicle.

In one embodiment, the user gives the command in step 1a to create a digital vehicle subkey having a restriction for a vehicle function. At least the data created in step 2a thus comprise information on the restriction. In such an embodiment, for example, the data generated in step 3, which comprise an unsigned digital vehicle subkey, then furthermore comprise the information on the restriction. The function of a signed digital vehicle subkey, which was generated on the basis of the unsigned digital vehicle subkey with the information on the restriction, is thus also restricted. The remote control 100 is thus configured not to trigger certain vehicle functions or only to trigger them to a restricted extent. If the restriction of the vehicle function relates, for example, to the access to the glove compartment, a user cannot open the glove compartment using this trained remote control.

In steps 7a and 7b, data on the signed digital vehicle subkey are then transferred from the remote control 100 to the external processing unit 204. The data on the signed digital vehicle subkey are first transferred for this purpose to the mobile terminal 202 in step 7a and then in step 7b from the mobile terminal 202 to the external processing unit 204.

In one embodiment, the data on the signed digital vehicle subkey are transferred in step 7b to a further external processing unit. The external processing unit 204 or the further external processing unit are each designed, for example, to manage at least the signed digital vehicle subkey on the basis of the data on the signed digital vehicle subkey. A user of the mobile terminal 202 can then block a signed digital vehicle subkey for the vehicle, for example, with the aid of the mobile terminal 202 and the external processing unit 204 or the further external processing unit. The external processing unit 204 or the further external processing unit are then designed, for example, to send data on the blocked signed digital vehicle subkey to the vehicle.

In one embodiment, the remote control 100 is furthermore configured as an electronic vehicle key for a further vehicle. For example, the same communication scheme 200 can be used here, wherein data which were created on the basis of the digital vehicle master key as described above are instead generated on the basis of a further digital vehicle master key. In one embodiment, in addition to the above-described data transfer steps 1b, 1c, 2a, 2b, 2c, 4a, 4b, 5a, 5c, 6a, 6b, 7a, 7b, still further data transfer steps take place which have the function of a reception confirmation, for example.

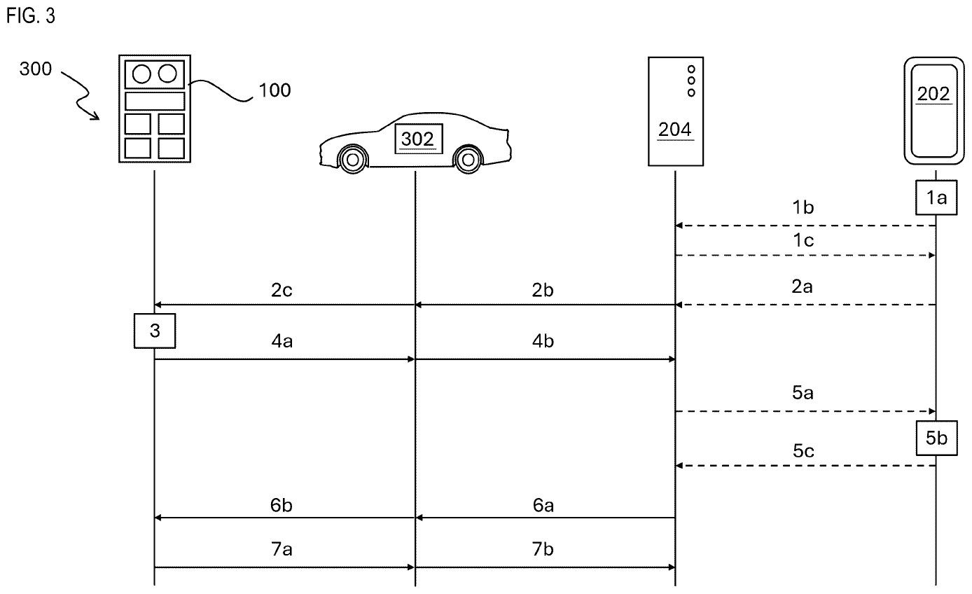

FIG. 3 shows a further communication scheme 300 of a system for configuring a remote control 100 as an electronic vehicle key for a vehicle. In the communication scheme 300, in addition to the remote control 100, the mobile terminal 202, and the external processing unit 204, a vehicle having a vehicle processing unit 302 is shown. Steps 1a, 1b, 1c, 2a, 3, 5a, 5b, and 5c take place in the same manner as for the communication scheme 200 described in FIG. 2. In contrast to the description of FIG. 2, at the solid data transfer arrows of steps 2b, 2c, 4a, 4b, 6a, 6b, 7a, and 7b, data are transferred with the aid of the vehicle processing unit 302 as an interconnected transfer unit 302 between the remote control 100 and the external processing unit 204.

In the exemplary embodiments described on the basis of FIGS. 1 to 3, at least the remote control, the mobile terminal, which comprises a digital vehicle master key for the vehicle, and the external processing unit 204 form a system for configuring the remote control 100 as an electronic vehicle key for the vehicle. Further elements and features shown in FIGS. 1 to 3 and mentioned in the preceding description can be part of the system. Method steps described on the basis of the system can likewise be part of the claimed method.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.
100 remote control
102 secure element
104 near field communication unit
106 Bluetooth communication unit
108 UWB communication unit
110 operating element
112 remote-control processing unit
200, 300 communication scheme
202 mobile terminal
204 external processing unit
302 vehicle processing unit

What is claimed is:

1. A system for configuring a remote control as an electronic vehicle key for a vehicle, the system comprising:
a vehicle processing unit;
a remote control configured to be trained;
a mobile terminal including a digital vehicle master key for the vehicle;
at least one external processing unit configured to secure and log a data transfer for generating a digital vehicle subkey for the vehicle;
wherein the remote control is configured to generate and store the digital vehicle subkey for the vehicle with aid of the mobile terminal and the external processing unit; and
wherein the mobile terminal or the vehicle processing unit is configured as an interconnected transfer unit to enable a data transfer between the external processing unit and the remote control.

2. The system according to claim 1, wherein the remote control is incapable of establishing an Internet connection via mobile wireless, Wi-Fi, or WLAN without the interconnected transfer unit.

3. The system according to claim 1, wherein the remote control and at least the mobile terminal or the vehicle processing unit are configured to communicate with one another via near field communication.

4. The system according to claim 2, wherein the remote control and at least the mobile terminal or the vehicle processing unit are configured to communicate with one another via near field communication.

5. The system according to claim 1, wherein the remote control and at least the mobile terminal or the vehicle processing unit are configured to communicate with one another via Bluetooth communication.

6. The system according to claim 2, wherein the remote control and at least the mobile terminal or the vehicle processing unit are configured to communicate with one another via Bluetooth communication.

7. The system according to claim 1, wherein the remote control and at least the mobile terminal or the vehicle processing unit are configured to communicate with one another via UWB communication.

8. The system according to claim 2, wherein the remote control and at least the mobile terminal or the vehicle processing unit are configured to communicate with one another via UWB communication.

9. The system according to claim 1, further comprising:
at least one further vehicle, which comprises a further vehicle processing unit;
wherein the mobile terminal comprises a further digital vehicle master key for the further vehicle, or a further mobile terminal, which comprises the further digital vehicle master key for the further vehicle;
wherein the remote control is configured to be additionally trained for the further vehicle;
wherein the external processing unit is configured to secure and log a data transfer for generating a further digital vehicle subkey for the further vehicle;
wherein the remote control is configured, via the external processing unit and either the mobile terminal which comprises the further digital vehicle master key for the further vehicle or the further mobile terminal which comprises the further digital vehicle master key for the further vehicle, to generate and store the digital vehicle subkey valid for the further vehicle; and
wherein the further mobile terminal or the further vehicle processing unit is configured as an interconnected transfer unit to enable a data transfer between the external processing unit and the remote control.

10. The system according to claim 2, further comprising:
at least one further vehicle, which comprises a further vehicle processing unit;
wherein the mobile terminal comprises a further digital vehicle master key for the further vehicle, or a further mobile terminal, which comprises the further digital vehicle master key for the further vehicle;
wherein the remote control is configured to be additionally trained for the further vehicle;
wherein the external processing unit is configured to secure and log a data transfer for generating a further digital vehicle subkey for the further vehicle;
wherein the remote control is configured, via the external processing unit and either the mobile terminal which comprises the further digital vehicle master key for the further vehicle or the further mobile terminal which comprises the further digital vehicle master key for the further vehicle, to generate and store the digital vehicle subkey valid for the further vehicle; and
wherein the further mobile terminal or the further vehicle processing unit is configured as an interconnected transfer unit to enable a data transfer between the external processing unit and the remote control.

11. A remote control configured as an electronic vehicle key for a vehicle,
wherein the remote control is configured to communicate via near field communication;
wherein the remote control is configured, via an interconnected transfer unit, to establish a data connection to at least one external processing unit, which is configured to secure and log the data transfer for generating a digital vehicle subkey for the vehicle; and
wherein the remote control is configured, via a mobile terminal which comprises a digital vehicle master key for the vehicle and the external processing unit, to generate and store the digital vehicle subkey for the vehicle.

12. The remote control according to claim 11, wherein the remote control is configured to transfer data via a Bluetooth data connection and a UWB data connection.

13. The remote control according to claim 11, wherein the remote control is incapable of establishing an Internet connection via mobile wireless, Wi-Fi, or WLAN without the interconnected transfer unit.

14. The remote control according to claim 12, wherein the remote control is incapable of establishing an Internet connection via mobile wireless, Wi-Fi, or WLAN without the interconnected transfer unit.

15. A method for configuring a remote control as an electronic vehicle key for a vehicle in a system including a vehicle processing unit, a mobile terminal, which comprises a digital vehicle master key for the vehicle, and at least one external processing unit, the method comprising:
generating and storing a digital vehicle subkey valid for the vehicle in the remote control via the mobile terminal and the external processing unit;
securing and logging a data transfer for generating the digital vehicle subkey for the vehicle via the external processing unit;
enabling, via the mobile terminal or the vehicle processing unit as an interconnected transfer unit, the data transfer between the external processing unit and the remote control.

16. The method according to claim 15, in which the remote control is incapable of establishing an Internet connection via mobile wireless, Wi-Fi, or WLAN without the interconnected transfer unit.

17. The method according to claim 15, in which the remote control, via the mobile terminal and the external processing unit, generates and stores a digital vehicle subkey valid for the vehicle and restricted in at least one vehicle function, in which a restriction of a vehicle function for the digital vehicle subkey is defined via the mobile terminal.

18. The method according to claim 16, in which the remote control, via the mobile terminal and the external processing unit, generates and stores a digital vehicle subkey valid for the vehicle and restricted in at least one vehicle function, in which a restriction of a vehicle function for the digital vehicle subkey is defined via the mobile terminal.

19. The method according to claim 17, in which the restriction includes at least one of a restriction of a usage period of time, a restriction of openable vehicle parts, a restriction of the usability of a navigation system, or a restriction of the usability of an infotainment system.
